(19) United States
(12) Patent Application Publication
(10) Pub. No.: US 2024/0086434 A1
(43) Pub. Date: Mar. 14, 2024

(54) ENHANCING DIALOGUE MANAGEMENT SYSTEMS USING FACT FETCHERS

(71) Applicant: INTERNATIONAL BUSINESS MACHINES CORPORATION, ARMONK, NY (US)

(72) Inventors: Harold Hannon, Lewisville, TX (US); Daniel M. Yellin, Raanana (IL)

(21) Appl. No.: 17/931,118

(22) Filed: Sep. 10, 2022

(51) Int. Cl. G06F 16/332; G06F 16/33; G06F 16/35

(52) U.S. Cl. CPC G06F 16/3329; G06F 16/3349; G06F 16/35

(57) ABSTRACT

An embodiment for enhancing dialogue management systems by enriching contextual data using fact fetchers. The embodiment may automatically intercept a received query sent to a dialogue management system. The embodiment may automatically tag language in the received query using a trained classifier and identify applicable associated fact fetchers. The embodiment may automatically utilize the associated fact fetcher to identify additional contextual data. The embodiment may automatically generate an updated dialogue including the additional contextual data. The embodiment may automatically run a trained language model on the updated dialogue to generate a response for the received query.

### BACKGROUND

The present application relates generally to the field of computer-based communication systems, and more particularly, to a method of enhancing dialogue management systems by enriching contextual data using fact fetchers.

A dialogue management system (DMS) or a conversational system/agent is a computer system intended to converse with a human in a structured manner. Dialogue management systems may employ text, speech, graphics, haptics, gestures, or other modes for communication on both the input and output channel. Task-oriented dialogue management systems generally provide a computer-based interface for explaining information in a repository (e.g. a database) to a user via a “dialog” that is conducted between the system and the user. Dialogue or conversational agents may include, for example, chat systems, chat agents, spoken dialog systems, digital personal assistants, and automated online assistants. An increasing number of dialogue management systems no longer include an explicit knowledge base, and instead utilize large language transformer models that involve deep neural net (DNN) learning techniques using potentially a billion parameters. Available contextual data improves the performance of a given dialogue management system employing large language transformer models involving deep neural net learning techniques.

### SUMMARY

According to one embodiment, a method, computer system, and computer program product for enhancing dialogue management systems by enriching contextual data using fact fetchers is provided. The embodiment may include automatically intercepting a received query sent to a dialogue management system. The embodiment may also include automatically tagging language in the received query using a trained classifier and identifying applicable associated fact fetchers. The embodiment may further include automatically utilizing the associated fact fetcher to identify additional contextual data. The embodiment may also include automatically generating an updated dialogue including the additional contextual data. The embodiment may further include automatically running a trained language model on the updated dialogue to generate a response for the received query.

### BRIEF DESCRIPTION OF THE SEVERAL VIEWS OF THE DRAWINGS

These and other objects, features and advantages of the present disclosure will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment; and

FIG. 2 illustrates an operational flowchart for a process of enhancing dialogue management systems by enriching contextual data using fact fetchers according to at least one embodiment; and

FIG. 3 illustrates a context and flow diagram depicting illustrative steps and components usable in an illustrative process of enhancing dialogue management systems by enriching contextual data using fact fetchers according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. The present disclosure may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present application relate to the field of computer-based communication systems, and more particularly, to a method of enhancing dialogue management systems by enriching contextual data using fact fetchers to improve the performance of a given dialogue management system. The following described exemplary embodiments provide a system, method, and program product to, among other things, automatically intercept a received query sent to a dialogue management system, automatically tag language in the received query using a trained classifier and identify applicable associated fact fetchers, automatically utilize the associated fact fetcher to identify additional contextual data, automatically generate an updated dialogue including the additional contextual data, and automatically run a trained language model on the updated dialogue to generate a response for the received query. Therefore, the presently described embodiments have the capacity to improve and enhance dialogue management systems by enriching contextual data using fact fetchers.

As previously described, a dialogue management system (DMS) or a conversational system/agent is a computer system intended to converse with a human in a structured manner. Dialogue management systems may employ text, speech, graphics, haptics, gestures, or other modes for communication on both the input and output channel. Task-oriented dialogue management systems generally provide a computer-based interface for explaining information in a repository (e.g. a database) to a user via a “dialog” that is conducted between the system and the user. Dialogue or conversational agents may include, for example, chat systems, chat agents, spoken dialog systems, digital personal assistants, and automated online assistants. An increasing number of dialogue management systems no longer include an explicit knowledge base, and instead utilize large language transformer models that involve deep neural net (DNN) learning techniques using potentially a billion parameters. Because these dialogue management systems have no explicit knowledgebase to rely on, the deep neural net of the language transformer model uses previously ingested information and dialogues it was trained on to respond to a user query. However, these large language transformer models utilizing deep neural nets must train on massive amounts of data. The core model typically undergoes substantial additional training to be useful in a specific domain. When not enough data exists to train for a unique situation, it cannot answer the question and is limited to answering questions that involve data that is mostly static. Furthermore, it cannot answer queries on fast changing facts since the answer will differ from the training data. Thus, to generate accurate predictions and responses, modern systems benefit from being able to leverage real-time contextual data to answer various questions. It is a great challenge for modern dialogue management systems (employing deep neural nets and large language transformer models) to be able to detect what contextual information is needed to answer a given question, especially in the presence of dynamic information, or contextual information of various input types (real-time audio, visual streams, facial expressions, tones etc.). Furthermore, once the contextual information needed is identified, the dialogue management system needs some way to obtain that information.

In view of these challenges, it would be desirable to provide improved methods of enhancing dialogue management systems by enriching contextual data using fact fetchers to improve the performance of a given dialogue management system for any business or enterprise that utilizes dialogue management systems. According to at least one embodiment of a computer system capable of employing methods in accordance with the present invention to automatically enhance dialogue management systems by enriching contextual data using fact fetchers, the method, system, computer program product may automatically intercept a received query sent to a dialogue management system. The method, system, computer program product may automatically tag language in the received query using a trained classifier and identify applicable associated fact fetchers. According to one embodiment, the method, system, computer program product may then automatically utilize the associated fact fetcher to identify additional contextual data. The method, system, computer program product may automatically generate an updated dialogue including the additional contextual data. Then, the method, system, computer program product may automatically run a trained language model on the updated dialogue to generate a response for the received query. In turn, the method, system, computer program product has provided improved methods for automatically enhancing dialogue management systems by enriching contextual data using fact fetchers. Described embodiments provide a method by which dialogue management systems utilizing deep neural nets and large language transformers can automatically determine what contextual information is ideal for answering a given question, identify a way to obtain the ideal contextual information, and ultimately use the ideal contextual information to generate an updated dialogue that it may process to generate a more informed and accurate answer.

The present invention may be a system, a method, and/or a computer program product at any possible technical detail level of integration. The computer program product may include a computer readable storage medium (or media) having computer readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

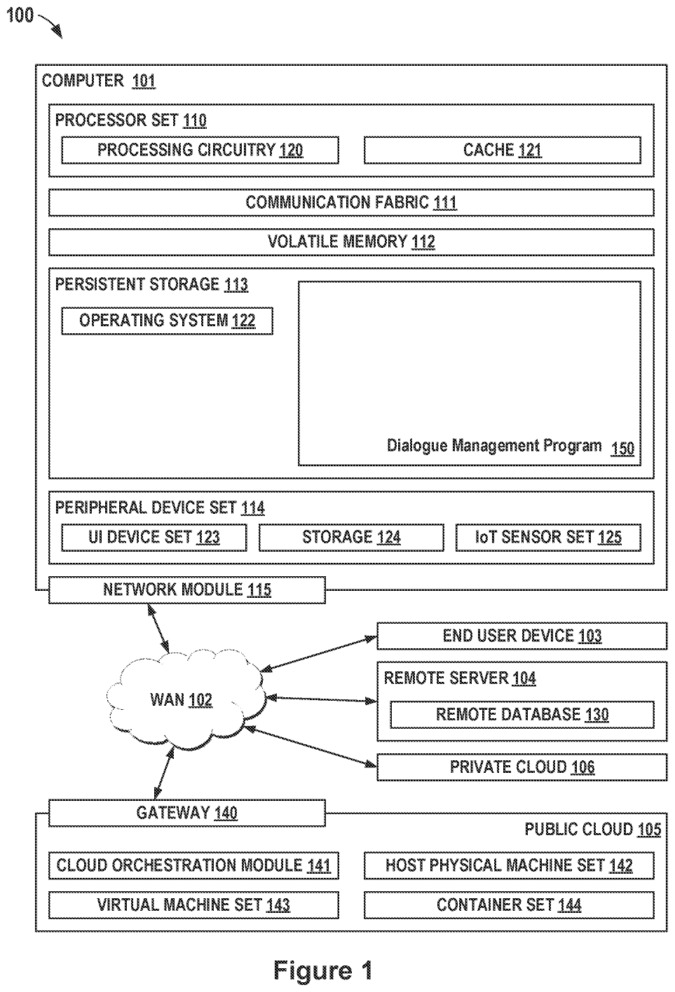

Referring now to FIG. 1, a computing environment 100 contains an example of an environment for the execution of at least some of the computer code involved in performing the inventive methods, such as dialogue management program/code 150. In addition to dialogue management code 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and dialogue management code 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in dialogue management code 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in dialogue management 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

According to the present embodiment, the dialogue management program 150 may be a program capable of automatically intercepting a received query sent to a dialogue management system. Dialogue management program 150 may then automatically tag language in the received query using a trained classifier and identify applicable associated fact fetchers. Next, dialogue management program 150 may automatically utilize the associated fact fetcher to identify additional contextual data. Dialogue management program 150 may then automatically generate an updated dialogue including the additional contextual data. Thereafter, dialogue management program 150 may automatically run a trained language model on the updated dialogue to generate a response for the received query. In turn, dialogue management program 150 has provided improved methods for automatically enhancing dialogue management systems by enriching contextual data using fact fetchers. Described embodiments provide a method by which dialogue management systems utilizing deep neural nets and large language transformers can automatically determine what contextual information is ideal for answering a given question, identify a way to obtain the ideal contextual information, and ultimately use the ideal contextual information to generate an updated dialogue that it may process to generate a more informed and accurate answer.

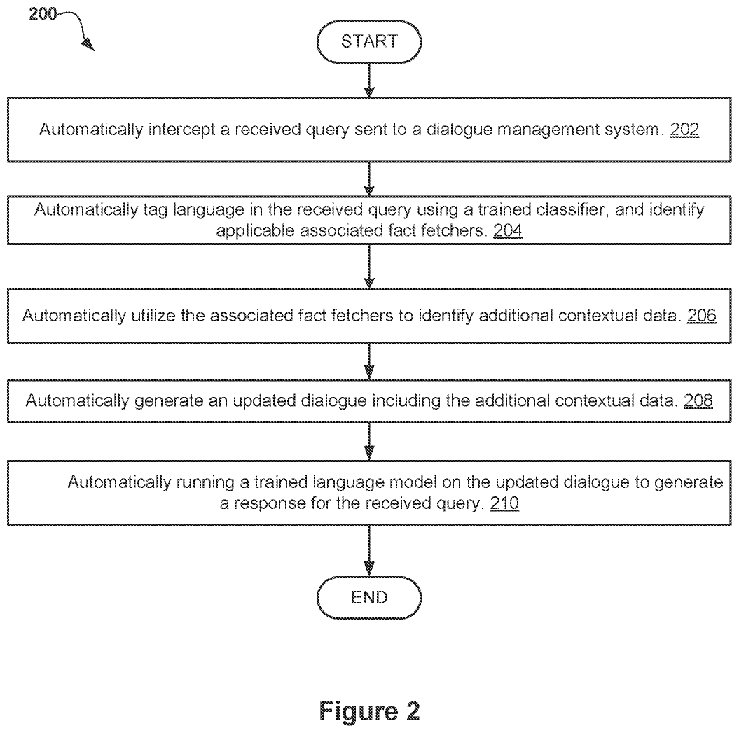

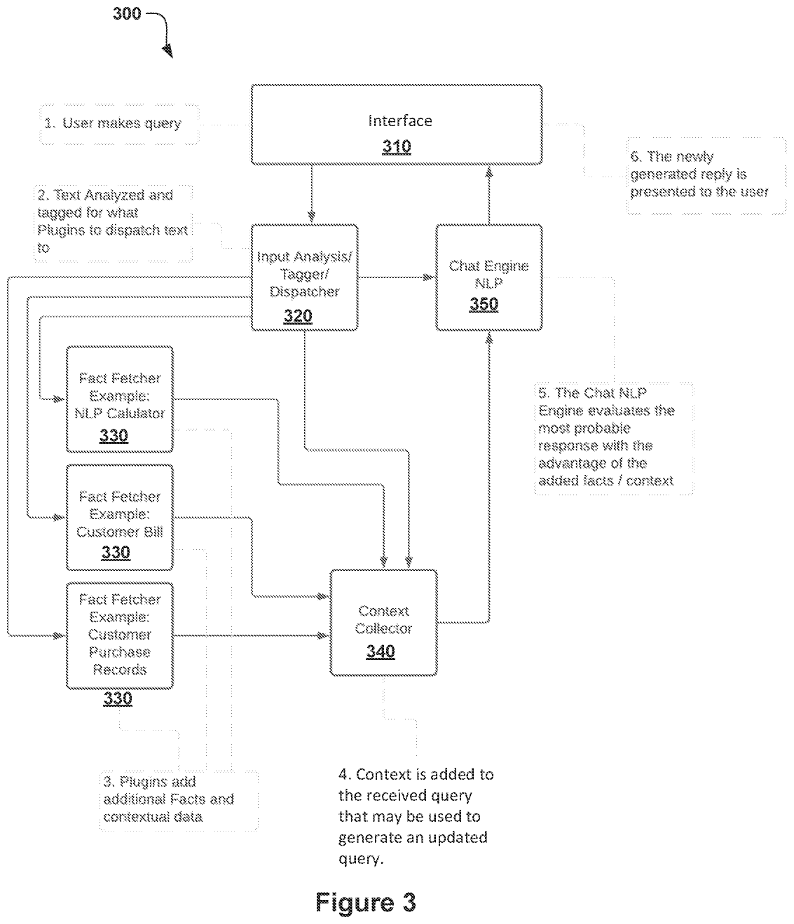

Referring now to FIG. 2, an operational flowchart depicting a process 200 for automatically enhancing dialogue management systems by enriching contextual data using fact fetchers according to at least one embodiment is provided. FIG. 3 depicts a context and flow diagram 300 depicting illustrative steps and components usable for performing process 200 described below. Accordingly, certain illustrative steps and components shown in FIG. 3 are referenced below.

At 202, dialogue management program 150 automatically intercepts a received query sent to a dialogue management system. In embodiments, dialogue management program 150 intercepts the received query input into a dialogue management system before the dialogue management system has a chance to process the query. Dialogue management program 150 may be configured to engage and communicate with exemplary dialogue management systems including pretrained large language transformer models trained with customer dialogues for a given domain to obtain an exemplary Deep Neural Network (DNN) ‘D’.

A neural network, as the name implies, is roughly modeled after a biological neural network (e.g., a human brain). A biological neural network is made up of a series of interconnected neurons, which affect one another. For example, a first neuron can be electrically connected by a synapse to a second neuron through the release of neurotransmitters (from the first neuron) which are received by the second neuron. These neurotransmitters can cause the second neuron to become excited or inhibited. A pattern of excited/inhibited interconnected neurons eventually lead to a biological result, including thoughts, muscle movement, memory retrieval, etc. While this description of a biological neural network is highly simplified, the high-level overview is that one or more biological neurons affect the operation of one or more other bio-electrically connected biological neurons. An electronic neural network similarly is made up of electronic neurons. However, unlike biological neurons, electronic neurons are never technically “inhibitory”, but are only “excitatory” to varying degrees.

In a DNN, neurons are arranged in layers, known as an input layer, hidden layer(s), and an output layer. The input layer includes neurons/nodes that take input data and send it to a series of hidden layers of neurons, in which neurons from one layer in the hidden layers are interconnected with neurons in a next layer in the hidden layers. The final layer in the hidden layers then outputs a computational result to the output layer, which is often a single node for holding vector information.

In embodiment, dialogue management program 150 is configured to communicate and engage with dialogue management systems including DNN's and may also be configured to engage with other machine learning systems, such as Convolution Neural Networks (CNN). In the context of this disclosure, a DNN may be used to evaluate text/numeric data using corrected training text ground truth data, while a CNN may be used to evaluate an image using corrected training image ground truth data. The DNN may be trained to recognize certain terms, nouns, phrases, etc. in an utterance, or by other context-based systems using, for example, natural language processing. The DNN may further be trained to rank answers to a particular question based on the intent and entities (e.g., certain words, phrases, terms, etc.) in the question.

At 204, dialogue management program 150 automatically tags language in the received query using a trained classifier and identifies applicable associated fact fetchers. The classifier may include and utilize its own deep neural net to tag sentences, or, in other embodiments, the classifier may be trained on natural language sets, intent data sets, entity data sets, and any other useful dataset to help the classifier more efficiently tag a received query. Once an exemplary query is received, dialogue management program 150 utilizes the classifier to return a set of probabilities indicating how likely the received query relates to each known class, for example Classes C1, C2, C3, etc. If no single class is determined to have a significantly higher probability of being applicable to the sentences in the received query than the other classes, then a summarizer may be used to summarize the latter portion of the received query to transform what is input into the classifier enough to improve the chance that a classification will stand out as most probable to be applicable. In other words, if no single class is determined to meet a threshold probability of being applicable to a given sentence in the query, then a summarizer may be used in an attempt to transform the sentence enough to increase the odds that a classification will meet a threshold probability of being applicable such that a single class may be assigned by the classifier. For example, a received exemplary query for a dialogue management system in the hotel domain includes the sentences “Guest: My hotel bill does not make sense. My last stay I was charged 110 dollars a night, but now I am being charged 120 dollars a night.” Dialogue management program 150 would use an exemplary classifier CL to tag the language in this received query. If dialogue management program 150 detects that no single class met a threshold probability (to be assigned a specific classification) of being applicable to the received query or sentence therein, it may then use a summarizer to summarize the query, or it may summarize not only the query, but additional preceding parts of the dialogue to enhance the ability of the system to get a more precise classification. In the example above, regarding the sentence related to the guest's last stay and what the guest was charged each night, dialogue management program 150 may employ a summarize to isolate and summarize the latter portion of any given query, in this case the last sentence relating to the dollar amounts charged for previous stays (while temporarily removing from consideration the portion related to the hotel bill not making sense). The classifier is then more likely to determine a class having a significantly higher probability of being applicable that dialogue management program 150 may then use to tag the language in the received query.

Once dialogue management program 150 has tagged the language in the received query using the classifier, dialogue management program 150 may automatically identify associated fact fetchers. In the context of this disclosure, fact fetchers are components of an exemplary dialogue management system that are configured to retrieve facts and contextual data relevant to a specific classification or class. In embodiments, each Factfinder F1, F2, F3, may be associated with a given class or classification C1, C2, C3. Fact fetchers may be manually or automatically built. In many instances, it is assumed that the builder will be able to infer from the classifications in a given domain what information is useful and configure the fact fetcher accordingly.

In some embodiments, alternative methods may be used to determine what information is relevant for a given classification. For example, in some embodiments, many dialogues may be automatically collected in which a dialogue management system was successfully able to generate a helpful response. Next, an exemplary training algorithm may remove information (usually a sentence) from the dialogue and see if the correct answer is still given. This can be done by removing one sentence at a time and rerunning the dialogue through the dialogue management system or bot to answer the query (this time without the chosen sentence). Alternatively, an exemplary training algorithm can randomly select sentences to be removed. If removing a given sentence from the dialogue results in the incorrect answer, then it is known that that sentence is important to answer the question correctly. Next, an exemplary training system may classify all those sentences that are found to be ideal to generate and answer the query correctly resulting in sentence classifications K1, K2 . . . . Each Kj has weight W(j) associated with it that indicates the extent to which information of type Kj is useful to answer queries of a given query classification Ci. If a given Kj is used a lot to correctly answer queries it has a higher weight than another that is used less. This allows the exemplary training algorithm to sort sentences and information that is ideal for generating answers to a given query of a given class. This information may be used to help build a fact finder for a given class that retrieves information of type K1, K2 because a training algorithm (or builder if built manually) will only retrieve information of type Kj if Kj has significant weight. In alternative embodiments, machine learning algorithms may be used to predict which sentence in a given dialogue is most useful in answering a given received query.

As stated above, once dialogue management program 150 tags the language in the received query, it will automatically identify applicable associated fact fetchers. Using the example above, if dialogue management program 150 tags the exemplary received query with a classification corresponding to ‘C1’ a class related to ‘Customer History’, then dialogue management program 150 may subsequently automatically identify an associated exemplary fact fetcher F1: CustomerHistoryFetcher associated with this classification.

Fact fetchers (sometimes referred to as fact finders) may retrieve relevant facts and contextual data for a given classification in any suitable known manner. For example, in some embodiments an exemplary fact fetcher may retrieve relevant facts and contextual data by invoking an API on a company-specific or third-party server, querying an internal or external database, asking a user for additional input, invoking customized logic, or performing calculations such as adding a list of numbers or other complex math calculations. In other embodiments, the fact fetchers may be configured to utilize secondary tools including for example, cameras, microphones, sensors, etc. to detect facial expressions, audio cues such as tone and volume, and other contextual data that may be identified using the secondary tools. This is a non-exhaustive list, and any known steps for retrieving relevant facts and contextual data may be used.

In some embodiments, when multiple classifications are identified and ranked with relatively similar probabilities of applying to a given received query, dialogue management program 150 may tag the received query with all highly ranking classifications and subsequently identify associated fact fetchers for each class to receive and combine facts and contextual data relating to all identified classes.

At 206, dialogue management program 150 automatically utilizes the associated fact fetcher to identify additional contextual data. Consider the example discussed above in which dialogue management program 150 automatically used the classifier to identify a classification for the received query corresponding to ‘C1’ a class related to ‘Customer History’, and subsequently, automatically identified an associated exemplary fact fetcher F1: CustomerHistoryFetcher associated with this classification. At 206, dialogue management program 150 may automatically utilize associated fact fetcher F1: CustomerHistoryFetcher to identify additional contextual data. In this instance, the identified additional contextual data may include the location, room rates, and any extra charges for the guest's previous and current reservations, i.e., facts and contextual data associated with the customer's history at the hotel. In embodiments, the associated fact fetcher may further examine earlier portions of the dialogue to extract additional relevant information or contextual data.

At 208, dialogue management program 150 automatically generates an updated dialogue including the additional contextual data. For example, using the exemplary query discussed above, dialogue management program may automatically generate an updated dialogue including the additional contextual data and facts identified by fact fetcher F1 regarding the location, room rates, and any extra charges for the guest's previous and current reservations. In embodiments, dialogue management program 150 may use a context collector to insert the contextual data into an updated dialogue that may then be inserted the current narrative or dialogue between the dialogue management system and the user. In the example above, the generated updated dialogue may state, for example. “(C1) CustomerHistoryFetcher: Guest Robert Jones visited the hotel JustPotatoes in Boise Idaho on May 3, 2021. His bill was $110, including $100 room rate and $10 in taxes. (C2) CustomerHistoryFetcher: Guest Robert Jones is visiting the hotel BigApple in New York City on Sep. 22, 2021. His bill is $120, including $100 room rate and $20 in taxes.” Accordingly, dialogue management program 150 has now inserted an updated dialogue including the additional contextual data that a trained language model of an exemplary dialogue management system would be unable to access previously. Without the updated dialogue including the additional facts and contextual data, there was a much higher probability that the dialogue management system would be unable to generate a helpful response and would have to subsequently connect the guest to a customer service representative, creating additional cost for the business and additional hassle for the guest. Instead, as will be discussed in more detail below in connection with step 210, dialogue management program 150 may utilize a trained language model to generate a response for the received query using the updated dialogue. In this example, a response may be generated stating the following: “Bot: You are being charged $120 a night which includes $100 for the room charge and $20 in taxes. During your last stay, you were charged $100 for the room and $10 in taxes.”

At 210, dialogue management program 150 automatically runs a trained language model on the updated dialogue to generate a response for the received query. The dialogue management system including the trained language model may use a natural language processing engine to evaluate the most probable response with the advantage of the added facts and contextual data contained in the updated dialogue. Consider an example in which the above-discussed conversation continues. In response to the bot stating “Bot: You are being charged $120 a night which includes $100 for the room charge and $20 in taxes. During your last stay, you were charged $100 for the room and $10 in taxes,” a customer may then input the query “So why was I charged more taxes for this stay?.” At this point, the dialogue management system may be unable to generate a helpful response and transfer the guest to customer service. However, if the dialogue management system utilizes presently described embodiments, then dialogue management program 150 may use a classifier to tag the query as being related to class C2, and identify an associated fact fetcher F2 TaxInfoCollector. After utilizing fact fetcher F2 to identify additional facts and contextual data, dialogue management program 150 may then generate an updated dialogue including the following: “(C3) TaxInfoCollector: Boise Idaho tax rate is 10%, (C4) TaxInfoCollector: New York City tax rate is 20%” Now, at 210, dialogue management program 150 may automatically run the trained language model on the updated dialogue, with the benefit of the additional contextual data and facts, to generate a response for the received query. For example, dialogue management program 150 may generate a response stating “Your last stay was in Idaho where the tax rate is 10% of the room charge. Your current stay is in New York City where the tax rate is 20% of the room charge.” This generated response may ultimately be presented to a user using any suitable user interface.

Accordingly, dialogue management program 150 has provided a mechanism by which the exemplary dialogue management system discussed above could utilize deep neural nets and large language transformers to automatically and dynamically determine what contextual information is ideal for answering a given question, identify a way to obtain the ideal contextual information, and ultimately use the ideal contextual information to generate an updated dialogue that may be used to generate a more informed and accurate response. Thus, dialogue management program 150 may enhance dialogue management systems by enriching contextual data using fact fetchers to ultimately lower costs associated with having to redirect users to customer service. Additionally, dialogue management program 150 may increase user satisfaction by increasing the performance and accuracy of dialogue management systems employing dialogue management program 150.

FIG. 3 illustrates a context and flow diagram depicting illustrative steps and components usable in an illustrative process 300 of enhancing dialogue management systems by enriching contextual data using fact fetchers according to at least one embodiment. FIG. 3 includes 6 steps. In the first step, a user inputs a query into a dialogue management system using an interface 310. As described above, dialogue management program 150 intercepts the received query, and at step 2, the text is then analyzed and tagged for what plugins to dispatch the text to using input analysis tagger and dispatcher 320. At step 3, plugins including fact fetchers 330 are used to add additional facts and contextual data to the received query. At step 4, a context collector 340 is used to add context to the received query, and as described above, an updated dialogue is then generated. At step 5, a natural language processing (NLP) engine 350 may be run on the updated dialogue and used to evaluate and generate the most probable response with the advantages of the added facts and contextual data. Thereafter, at step 6, the newly generated reply or response is presented back to the user.

It may be appreciated that FIGS. 2-3 provide only illustrations of an exemplary implementation and do not imply any limitations with regard to how different embodiments may be implemented. Many modifications to the depicted environments may be made based on design and implementation requirements.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-based method of enhancing dialogue management systems by enriching contextual data using fact fetchers, the method comprising:
automatically intercepting a received query sent to a dialogue management system;
automatically tagging language in the received query using a trained classifier and identifying an applicable associated fact fetcher;
automatically utilizing the associated fact fetcher to identify additional contextual data;
automatically generating an updated dialogue including the additional contextual data; and
automatically running a trained language model on the updated dialogue to generate a response for the received query.

2. The computer-based method of claim 1, wherein the dialogue management system comprises a pretrained large language transformer model configured to utilize a deep neural network to generate the response to the received query.

3. The computer-based method of claim 1, wherein automatically tagging the language in the received query using the trained classifier further comprises:
automatically ranking one or more sentences in the received query to detect a class having a threshold probability of being applicable to the one or more sentences in the received query.

4. The computer-based method of claim 3, further comprising:
in response to detecting that no class has the threshold probability of being applicable to the one or more sentences in the received query, automatically using a summarizer to summarize a latter portion of the one or more received sentences; and
automatically ranking the summarized latter portion of the one or more received sentences to detect a class having the threshold probability of being applicable to the one or more sentences in the received query.

5. The computer-based method of claim 1, wherein utilizing the associated fact fetchers further comprises performing at least one of: invoking an API on a company-specific or third-party server, invoking customized logic, querying an external or internal database, asking a user for additional input, and performing a calculation or complex math calculation, or a combination thereof to identify the additional contextual data.

6. The computer-based method of claim 1, further comprising:
in response to detecting a plurality of applicable classes for the received query, automatically identifying a plurality of associated fact fetchers and automatically identifying additional the additional contextual data using each of the plurality of associated fact fetchers.

7. The computer-based method of claim 1, wherein the generated response for the received query is output to the user using a user interface.

8. A computer system, the computer system comprising:
one or more processors, one or more computer-readable memories, one or more computer-readable tangible storage medium, and program instructions stored on at least one of the one or more computer-readable tangible storage medium for execution by at least one of the one or more processors via at least one of the one or more computer-readable memories, wherein the computer system is capable of performing a method comprising:
automatically intercepting a received query sent to a dialogue management system;
automatically tagging language in the received query using a trained classifier and identifying an applicable associated fact fetcher;
automatically utilizing the associated fact fetcher to identify additional contextual data;
automatically generating an updated dialogue including the additional contextual data; and
automatically running a trained language model on the updated dialogue to generate a response for the received query.

9. The computer system of claim 8, wherein the dialogue management system comprises a pretrained large language transformer model configured to utilize a deep neural network to generate the response to the received query.

10. The computer system of claim 8, wherein automatically tagging the language in the received query using the trained classifier further comprises:
automatically ranking one or more sentences in the received query to detect a class having a threshold probability of being applicable to the one or more sentences in the received query.

11. The computer system of claim 10, further comprising:
in response to detecting that no class has the threshold probability of being applicable to the one or more sentences in the received query, automatically using a summarizer to summarize a latter portion of the one or more received sentences; and
automatically ranking the summarized latter portion of the one or more received sentences to detect a class having the threshold probability of being applicable to the one or more sentences in the received query.

12. The computer system of claim 8, wherein utilizing the associated fact fetchers further comprises performing at least one of: invoking an API on a company-specific or third-party server, invoking customized logic, querying an external or internal database, asking a user for additional input, and performing a calculation or complex math calculation, or a combination thereof to identify the additional contextual data.

13. The computer system of claim 8, further comprising:
in response to detecting a plurality of applicable classes for the received query, automatically identifying a plurality of associated fact fetchers and automatically identifying additional the additional contextual data using each of the plurality of associated fact fetchers.

14. The computer system of claim 8, wherein the generated response for the received query is output to the user using a user interface.

15. A computer program product, the computer program product comprising:
one or more computer-readable tangible storage medium and program instructions stored on at least one of the one or more computer-readable tangible storage medium, the program instructions executable by a processor capable of performing a method, the method comprising:
automatically intercepting a received query sent to a dialogue management system;
automatically tagging language in the received query using a trained classifier and identifying an applicable associated fact fetcher;
automatically utilizing the associated fact fetcher to identify additional contextual data;
automatically generating an updated dialogue including the additional contextual data; and
automatically running a trained language model on the updated dialogue to generate a response for the received query.

16. The computer program product of claim 15, wherein the dialogue management system comprises a pretrained large language transformer model configured to utilize a deep neural network to generate the response to the received query.

17. The computer program product of claim 15, wherein automatically tagging the language in the received query using the trained classifier further comprises:
automatically ranking one or more sentences in the received query to detect a class having a threshold probability of being applicable to the one or more sentences in the received query.

18. The computer program product of claim 17, further comprising:
in response to detecting that no class has the threshold probability of being applicable to the one or more sentences in the received query, automatically using a summarizer to summarize a latter portion of the one or more received sentences; and
automatically ranking the summarized latter portion of the one or more received sentences to detect a class having the threshold probability of being applicable to the one or more sentences in the received query.

19. The computer program product of claim 15, wherein utilizing the associated fact fetchers further comprises performing at least one of: invoking an API on a company-specific or third-party server, invoking customized logic, querying an external or internal database, asking a user for additional input, and performing a calculation or complex math calculation, or a combination thereof to identify the additional contextual data.

20. The computer program product of claim 15, further comprising:
in response to detecting a plurality of applicable classes for the received query, automatically identifying a plurality of associated fact fetchers and automatically identifying additional the additional contextual data using each of the plurality of associated fact fetchers.
